(19) United States
(12) Patent Application Publication
(10) Pub. No.: US 2021/0053804 A1
(43) Pub. Date: Feb. 25, 2021

(54) WINCH SPOOLING GUIDE BAR

(71) Applicant: Robert Bailey, Blairmore (CA)

(72) Inventor: Robert Bailey, Blairmore (CA)

(21) Appl. No.: 16/547,299

(22) Filed: Aug. 21, 2019

(51) Int. Cl. B66D 1/38

(52) U.S. Cl. CPC B66D 1/38

(57) ABSTRACT

The present invention provides a cable winch system with a cable guide bar handle and a cable guide clip for evenly distributing cable along a winch spool.

### BACKGROUND OF THE INVENTION

A winch mounted to the front of the vehicle is a fairly common site. Numerous persons and professions have found a very helpful device in this type of configuration. However, the helpfulness comes with one very significant difficulty. In winding up cable onto a winch it is very important to guide the cable such that the resulting spool on the winch has some level of uniformity. Most often, persons hold the cable and guide it on to the spool with their hand in order to wind the cable uniformly. Very often, persons scratch or cut their hands on the cable during the spooling process. There is a need for a simple device to assist in the spooling while protecting the hands of the user.

The present invention addresses this issue.

### SUMMARY OF THE INVENTION

The present invention is a system that will enable a person to safely wind a winch cable without having to hold the cable in their hand.

The system guides and steers cable onto winch spool as it is common that winch cables always end up full of jiggers that catch and tear up hands of the user.

In one embodiment, the present invention is a winch system comprising:
a cable guide bar or handle constructed and arranged for use with an existing vehicle mounted winch, said existing vehicle mounted winch having cable and a cable winch spool;
a base constructed and arranged to secure a cable guide bar pitovably attached to said cable guide bar;
a cable guide clip operatively associated with said cable guide handle whereby said cable guide clip threads and directs cable during spooling onto said cable winch spool.

In one embodiment, the cable guide handle is telescopically extendable and retractable.

The cable guide handle is constructed and arranged to move cable horizontally in relation to said cable winch spool.

In one embodiment, the invention is a winch system consisting of:
a cable guide bar or handle, telescopically extendable and retractable, constructed and arranged for use with an existing vehicle mounted winch, said existing vehicle mounted winch having cable and a cable winch spool, wherein said cable guide handle is constructed and arranged to move cable horizontally in relation to said cable winch spool;
a base constructed and arranged to secure a cable guide bar pitovably attached to said cable guide bar;
a cable guide clip operatively associated with said cable guide handle whereby said cable guide clip threads and directs cable during spooling onto said cable winch spool.

### BREIF DESCRIPTION OF THE SEVERAL VIEWS OF THE DRAWINGS

FIG. 1 is a partial front view demonstrating the system according to one embodiment of the present invention.

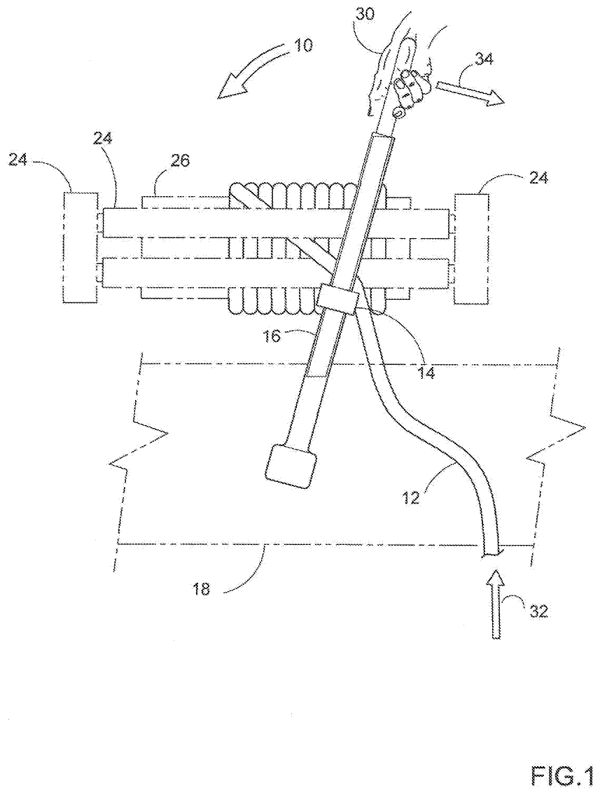

FIG. 2 is a side view demonstrating the system according to one embodiment of the present invention.

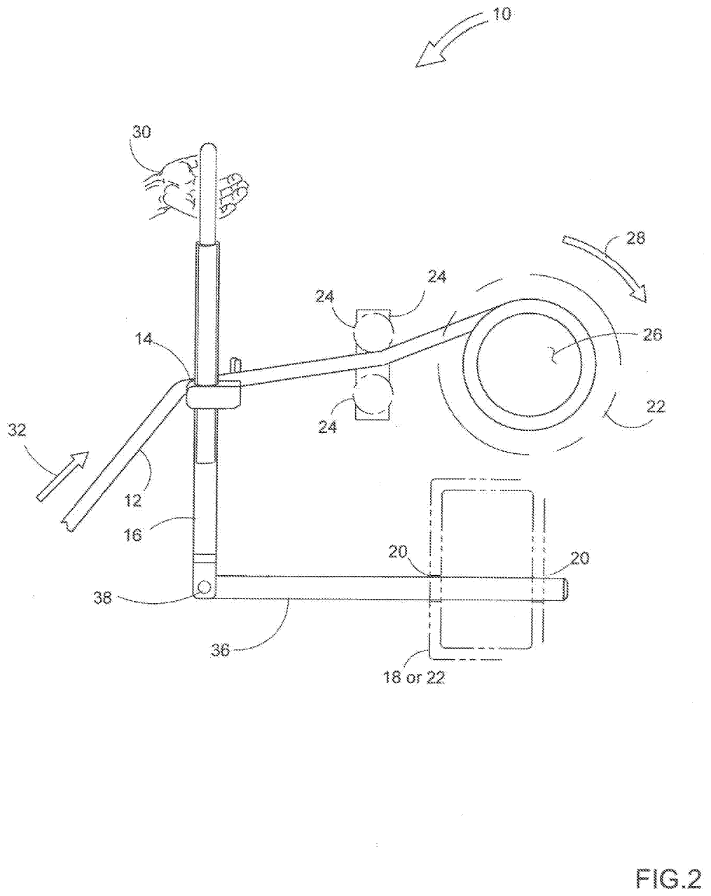

### DETAILED DESCRIPTION OF THE PREFERRED EMBODIMENT

The present invention provides winch system 10 that includes a vehicle mounted winch 22 that holds cable 12. The system utilizes an existing vehicle mounted winch and all components typically associated with existing vehicle mounted winches. Although the figures and descriptions include a winch 22 cable 12 cable winch spool 26 it is presented in this manner to demonstrate the configuration of system 10 utilizing existing components in concert with components of the inventive system.

The system utilizes a base 18 configured with orifice 20 constructed and arranged for cable guide bar 36 to pass therethrough. Guide bar 36 is connected to Cable guide handle 16 at pivot pin 38. In one embodiment, guide handle 16 it is constructed and arranged as a telescoping or adjustable length handle moved by a user 30 as desired.

Cable guide handle 16 has incorporated therewith cable guide clip 14. When cable 12 is spooled onto cable winch spool 26 through cable fair lead 24 a user moves cable guide handle 16 horizontally in relation to cable winch spool 26 in order to evenly distribute and spool cable 12 onto cable winch spool 26. In the spooling process, cable winch spool 26 rotates in the direction as indicated by spool rotational arrow 28 and cable 12 passes through cable guide clip 14 in the direction indicated by cable movement directional arrow 32.

As the spooling process proceeds, when cable 12 is being wound around cable winch spool 26 with each rotation, the user moves handle 16 that subsequently guides cable 12 through cable guide clip 14 in order to create a uniform spool.

As generally understood in the field of endeavor, cable guide clip 14 must be formed of material having sufficient strength to hold and guide cable 12 but should not be formed of a material that could potentially damage cable 12. One preferred construction would be a metal clip with a Teflon coating.

In one embodiment, the system is constructed and arranged to further provide opposing tension away from the direction of spooling in order that the spooling ultimately is taut.

While the invention has been described in its preferred form or embodiment with some degree of particularity, it is understood that this description has been given only by way of example and that numerous changes in the details of construction, fabrication, and use, including the combination and arrangement of parts, may be made without departing from the spirit and scope of the invention.

What is claimed:

1. A winch system comprising:
a cable guide handle constructed and arranged for use with an existing vehicle mounted winch, said existing vehicle mounted winch having cable and a cable winch spool;
a base constructed and arranged to secure a cable guide bar pitovably attached to said cable guide bar;
a cable guide clip operatively associated with said cable guide handle whereby said cable guide clip threads and directs cable during spooling onto said cable winch spool.

2. The system of claim 1 wherein said cable guide handle is telescopically extendable and retractable.

3. The system of claim 1 wherein said cable guide handle is constructed and arranged to move cable horizontally in relation to said cable winch spool.
